(19) United States
(12) Patent Application Publication
(10) Pub. No.: US 2023/0236296 A1
(43) Pub. Date: Jul. 27, 2023

(54) DISTANCE IMAGE ACQUISITION DEVICE AND DISTANCE IMAGE ACQUISITION METHOD

(71) Applicant: HAMAMATSU PHOTONICS K.K., Hamamatsu-shi, Shizuoka (JP)

(72) Inventors: Mitsuhito MASE, Hamamatsu-shi, Shizuoka (JP); Jun HIRAMITSU, Hamamatsu-shi, Shizuoka (JP); Akihiro SHIMADA, Hamamatsu-shi, Shizuoka (JP)

(73) Assignee: HAMAMATSU PHOTONICS K.K., Hamamatsu-shi, Shizuoka (JP)

(21) Appl. No.: 18/023,145

(22) PCT Filed: May 20, 2021
(86) PCT No.: PCT/JP2021/019222

§ 371 Date: Feb. 24, 2023

(30) Foreign Application Priority Data
Sep. 9, 2020 (JP) 2020-151136

(51) Int. Cl. G01S 7/4863; G01S 17/894; G01S 17/18

(52) U.S. Cl. CPC G01S 7/4863; G01S 17/894; G01S 17/18

(57) ABSTRACT

A distance image acquisition device includes a distance measurement sensor that detects a measurement light by transferring charges generated in a charge generation region in response to incidence of a measurement light reflected by a target object, to a charge accumulation region by using a transfer gate electrode. The charge generation region includes an avalanche multiplication region that causes avalanche multiplication. The control unit divides an entire distance range of a measurement target into the plurality of sections, controls the distance measurement sensor so as to perform measurements about a plurality of sections while varying a time difference between an emission timing of the measurement light by the light source and a transferring timing of the charges by the transfer gate electrode among the plurality of sections, and generates a distance image of the entire distance range based on the results of the measurements about the plurality of sections.

### TECHNICAL FIELD

One aspect of the present disclosure relates to a distance image acquisition device and a distance image acquisition method.

### BACKGROUND ART

As a distance measurement sensor for acquiring a distance image of a target object using an indirect TOF (Time of Flight) method, there is known a distance measurement sensor including a semiconductor layer provided with a light sensitive region and a photogate electrode and a transfer gate electrode provided on the semiconductor layer for each pixel (refer to, for example, Patent Literatures 1 and 2). According to such a distance measurement sensor, charges generated in the light sensitive region by an incident light can be transferred at a high speed.

### CITATION LIST

### Patent Literature

Patent Literature 1: Japanese Unexamined Patent Publication No. 2011-133464

Patent Literature 2: Japanese Unexamined Patent Publication No. 2013-206903

### SUMMARY OF INVENTION

### Technical Problem

In the above-described distance measurement sensor, the amount of light reflected by the target object and returning to the distance measurement sensor decreases as the distance to the target object increases. Thus, there is a limit to extend a measurement distance. In addition, although a pulse width of the measurement light needs to be widened in order to extend the measurement distance, but the widening of the pulse width degrades a distance accuracy.

A purpose of one aspect of the present disclosure is to provide a distance image acquisition device and a distance image acquisition method capable of extending a measurement distance and ensuring a distance accuracy.

### Solution to Problem

A distance image acquisition device according to one aspect of the present disclosure includes a light source emitting a measurement light; a distance measurement sensor that includes a charge generation region, a charge accumulation region, and a transfer gate electrode arranged on a region between the charge generation region and the charge accumulation region and detects the measurement light by transferring charges generated in the charge generation region in response to incidence of the measurement light emitted from the light source and reflected by a target object, to the charge accumulation region by using the transfer gate electrode; and a control unit that controls the distance measurement sensor and generates a distance image of the target object based on a detection result of the distance measurement sensor, wherein the charge generation region includes an avalanche multiplication region that causes avalanche multiplication, wherein the control unit divides an entire distance range of a measurement target into a plurality of sections, controls the distance measurement sensor so as to perform measurements about the plurality of sections while varying a time difference between an emission timing of the measurement light by the light source and a transfer timing of the charges by the transfer gate electrode among the plurality of sections, and generates the distance image of the entire distance range based on the results of the measurements about the plurality of sections.

In this distance image acquisition device, the charge generation region includes an avalanche multiplication region that causes avalanche multiplication. Accordingly, the sensitivity of the distance measurement sensor can be increased, and as a result, the measurement distance can be extended. On the other hand, as described above, generally, the pulse width of the measurement light needs to be widened in order to extend a measurement distance, and widening the pulse width degrades a distance accuracy. In this respect, in this distance image acquisition device, the entire distance range of the measurement target is divided into the plurality of sections, the measurements about the plurality of sections are performed while varying the time difference between the emission timing of the measurement light by the light source and the transfer timing of the charges by the transfer gate electrode among the plurality of sections, and a distance image of the entire distance range is generated based on the results of the measurements about the plurality of sections. Accordingly, even when the measurement distance is long, the widening of the pulse width of the measurement light can be suppressed, and the distance accuracy can be ensured. In addition, when simply dividing into a plurality of sections, the charge accumulation time (exposure time) may decrease and the charge accumulation amount may be insufficient, but in the distance image acquisition device, since the charge generation region includes the avalanche multiplication region, the shortage of the charge accumulation amount can be suppressed. For this reason, it is hardly necessary to increase the charge accumulation time in order to compensate for the shortage of the charge accumulation amount. Furthermore, by performing the division into a plurality of sections, the deterioration in the measurement accuracy caused by the existence of a transparent object, a semi-transparent object, or the like between the distance measurement sensor and the target object can be suppressed (multi-echo). As described above, according to this distance image acquisition device, a measurement distance can be extended, and a distance accuracy can be ensured.

The plurality of sections include a first section and a second section farther from the light source than the first section, and the control unit controls the distance measurement sensor so that the charges accumulated in the charge accumulation region are read at a higher reading frequency in the measurement about the first section than in the measurement about the second section. In this case, the saturation of the charge generation region can be suppressed during the measurement about the first section which is closer to the light source than the second section. The suppression of such saturation is particularly effective when the charge generation region includes the avalanche multiplication region.

The plurality of sections include a first section and a second section farther from the light source than the first section, and the control unit may control the distance measurement sensor so that, the charges are transferred to the charge accumulation region at a lower transfer frequency in the measurement about the first section than in the measurement about the second section. In this case, the saturation of the charge generation region can be suppressed during the measurement about the first section which is closer to the light source than the second section.

The charge accumulation region may include a pair of charge accumulation regions, and the transfer gate electrode may include a pair of transfer gate electrodes arranged respectively on the regions between the charge generation region and the pair of charge accumulation regions. In such a configuration, the measurements about the plurality of sections can be performed by dividing the entire distance range of the measurement target into the plurality of sections and while varying the time difference between the emission timing of the measurement light by the light source and the transfer timing of the charges by the transfer gate electrode among the plurality of sections.

The distance measurement sensor may include only one region as the charge accumulation region and may include only one electrode as the transfer gate electrode. In such a configuration, the measurements about the plurality of sections can be performed by dividing the entire distance range of the measurement target into the plurality of sections and while varying the time difference between the emission timing of the measurement light by the light source and the transfer timing of the charges by the transfer gate electrode among the plurality of sections.

The control unit may vary the time difference between the emission timing and the transfer timing among the plurality of sections by fixing the emission timing and shifting the transfer timing from the emission timing. In this case, the time difference between the emission timing and the transfer timing can be allowed to be varied among the plurality of sections.

The control unit may vary the time difference between the emission timing and the transfer timing among the plurality of sections by fixing the transfer timing and shifting the emission timing from the transfer timing. In this case, the time difference between the emission timing and the transfer timing can be allowed to be varied among the plurality of sections.

The charge accumulation times in the measurements about the plurality of sections may be equal to each other. In this case, for example, the distance image can be acquired at a higher speed than the case where the charge accumulation time is increased in the measurement about the section which is far from the light source and in which the charge accumulation amount is likely to be insufficient.

A distance image acquisition method according to one aspect of the present disclosure is a distance image acquisition method of acquiring a distance image of a target object, using a light source emitting a measurement light; and a distance measurement sensor taht includes a charge generation region, a charge accumulation region, and a transfer gate electrode arranged on a region between the charge generation region and the charge accumulation region and detects the measurement light by transferring charges generated in the charge generation region in response to incidence of the measurement light emitted from the light source and reflected by a target object, to the charge accumulation region by using the transfer gate electrode, the charge generation region including an avalanche multiplication region that causes avalanche multiplication, the distance image acquisition method including: dividing an entire distance range of a measurement target into a plurality of sections; performing measurements about the plurality of sections while varying the time difference between the emission timing of the measurement light by the light source and the transfer timing of the charges by the transfer gate electrode among the plurality of sections; and generating the distance image of the entire distance range based on the results of the measurements about the plurality of sections.

In this distance image acquisition method, for the reasons described above, a measurement distance can be extended, and a distance accuracy can be ensured.

### Advantageous Effects of Invention

According to one aspect of the present disclosure, it is possible to provide a distance image acquisition device and a distance image acquisition method capable of extending a measurement distance and ensuring a distance accuracy.

### BRIEF DESCRIPTION OF DRAWINGS

FIG. 1 is a configuration diagram of a distance image acquisition device according to an embodiment.

FIG. 2 is a plan view of a pixel portion of a distance measurement sensor.

FIG. 3 is a cross-sectional view along line III-III of FIG. 2.

FIG. 4 is a cross-sectional view along line IV-IV of FIG. 2.

FIG. 5 is a timing chart for describing a distance image acquisition method of the embodiment.

FIG. 6 is a timing chart for describing the distance image acquisition method of the embodiment.

FIG. 7 is a plan view of a pixel portion of a distance measurement sensor of Modified Example 1.

FIG. 8 is a cross-sectional view along line VIII-VIII of FIG. 7.

FIG. 9 is a timing chart describing a distance image acquisition method of Modified Example 1.

FIG. 10 is a timing chart describing a distance image acquisition method of Modified Example 2.

FIG. 11 is a timing chart describing a distance image acquisition method of Modified Example 3.

### DESCRIPTION OF EMBODIMENTS

Hereinafter, embodiments of the present disclosure will be described in detail with reference to the drawings. It is noted that, in each figure, the same or corresponding components are denoted by the same reference numerals, and redundant description thereof are omitted.

### Distance Image Acquisition Device

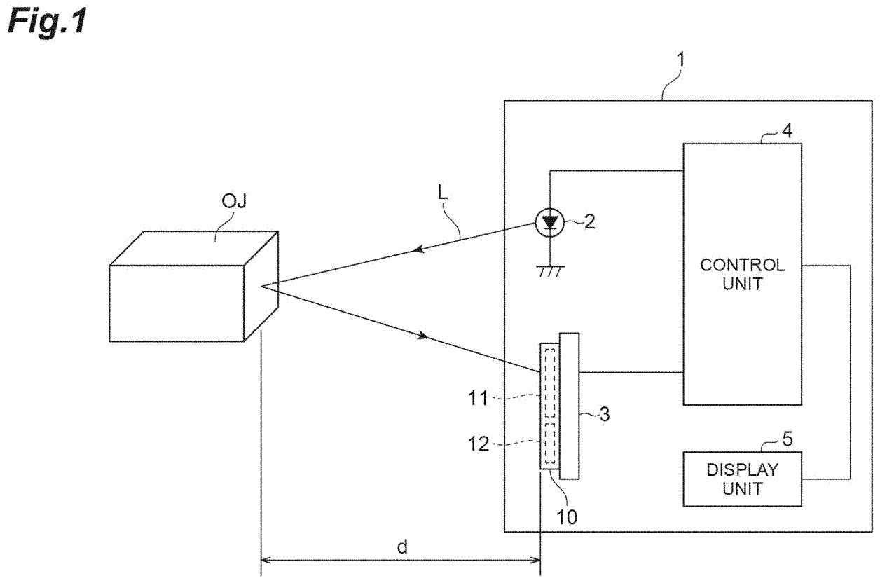

As illustrated in FIG. 1, a distance image acquisition device 1 includes a light source 2, a distance measurement sensor 10, a signal processing unit 3, a control unit 4, and a display unit 5. The distance image acquisition device 1 is a device that acquires a distance image of a target object OJ by using an indirect TOF method. The distance image is an image containing information on a distance d to the target object OJ.

The light source 2 emits a pulsed light (measurement light) L. The light source 2 includes, for example, infrared LEDs and the like. The pulsed light L is, for example, a near-infrared light, and a frequency of the pulsed light L is, for example, 10 kHz or more. The distance measurement sensor 10 detects the pulsed light L emitted from the light source 2 and reflected by the target object OJ. The distance measurement sensor 10 is configured by monolithically forming a pixel unit 11 and a CMOS read circuit unit 12 on a semiconductor substrate (for example, a silicon substrate). The distance measurement sensor 10 is mounted on the signal processing unit 3.

The signal processing unit 3 controls the pixel unit 11 and the CMOS read circuit unit 12 of the distance measurement sensor 10. The signal processing unit 3 performs predetermined processing on a signal output from the distance measurement sensor 10 to generate a detection signal. The control unit 4 controls the light source 2 and the signal processing unit 3. The control unit 4 generates the distance image of the target object OJ based on the detection signal output from the signal processing unit 3. The display unit 5 displays the distance image of the target object OJ generated by the control unit 4.

### Distance Measurement Sensor

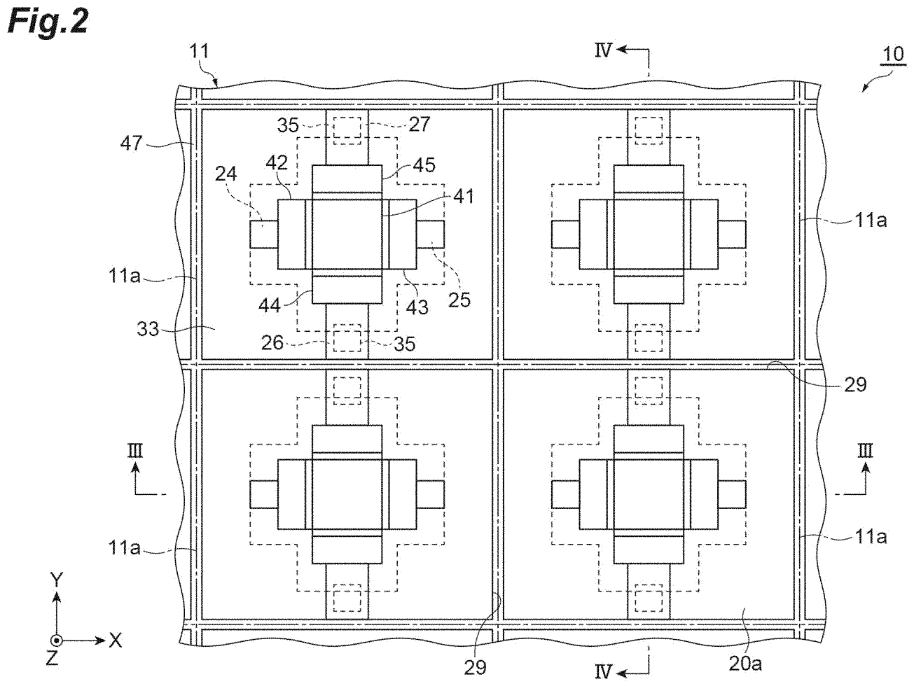

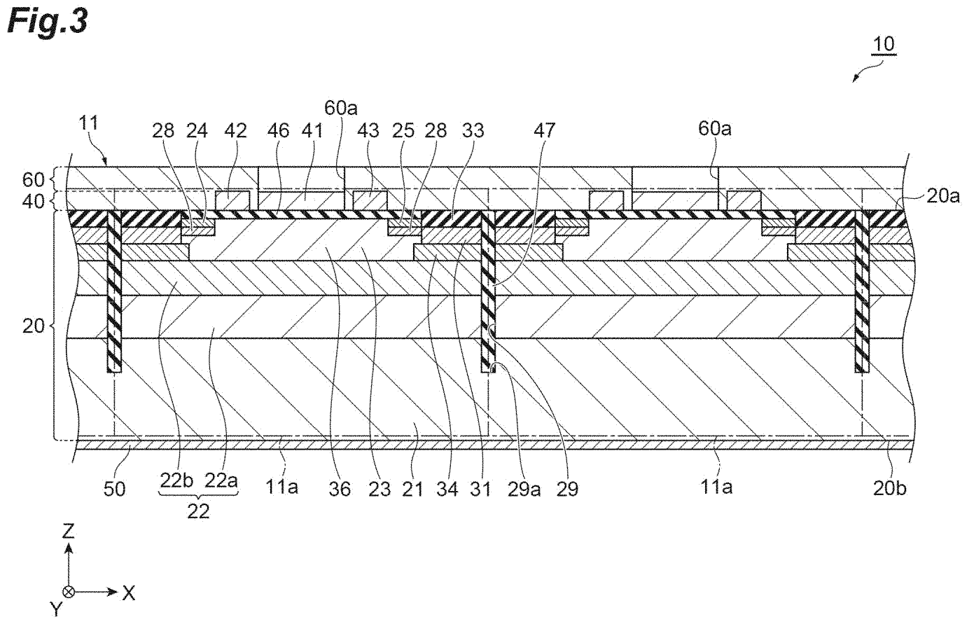

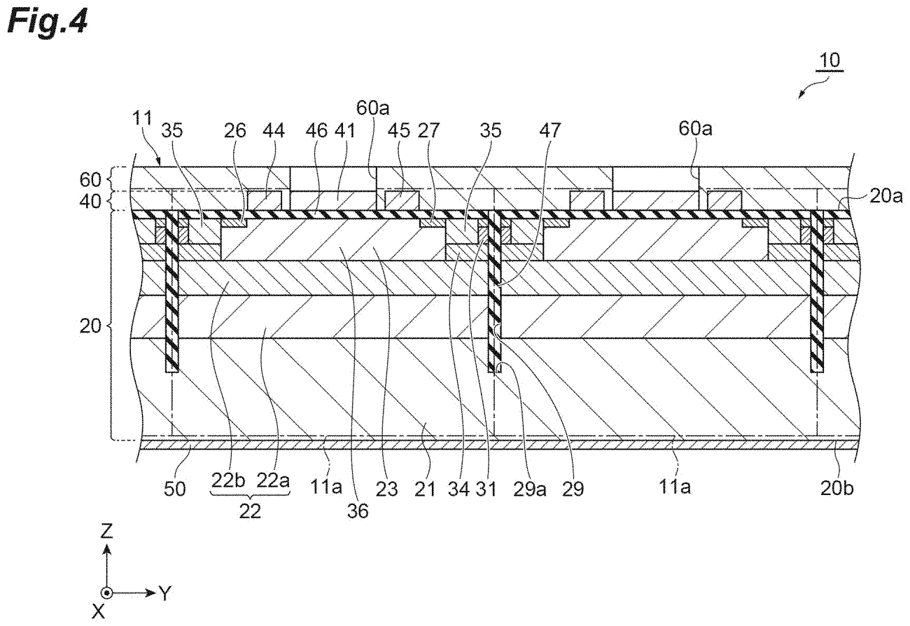

As illustrated in FIGS. 2, 3, and 4, the distance measurement sensor 10 includes a semiconductor layer 20 and an electrode layer 40 in the pixel unit 11. The semiconductor layer 20 has a first surface 20a and a second surface 20b. The first surface 20a is a surface on one side of the semiconductor layer 20 in the thickness direction. The second surface 20b is a surface on the other side in the thickness direction of the semiconductor layer 20. The electrode layer 40 is provided on the first surface 20a.

The semiconductor layer 20 and the electrode layer 40 constitute a plurality of pixels 11a arranged along the first surface 20a. The plurality of pixels 11a are, for example, two-dimensionally arranged along the first surface 20a. These pixels 11a constitute the distance image. In the distance image, each pixel 11a contains information on the distance d to the target object OJ. Hereinafter, the thickness direction of the semiconductor layer 20 is called a Z direction, one direction perpendicular to the Z direction is called an X direction, and the direction perpendicular to both the Z direction and the X direction is called a Y direction. One side in the Z direction is called the first side, and the other side in the Z direction (the side opposite to the first side) is called the second side. In FIG. 2, an illustration of a wiring layer 60 to be described later is omitted.

Each pixel 11a includes, in the semiconductor layer 20, a semiconductor region 21, an avalanche multiplication region 22, a charge distribution region 23, a pair of charge accumulation regions 24 and 25, a pair of charge discharge regions 26 and 27, a plurality of charge blocking regions 28, a well region 31, a LOCOS (Local Oxidation of Silicon) region 33, a barrier region 34, and a pair of sink regions 35. Each of the regions 21 to 28 and 31 to 35 are formed by performing various processes (for example, etching, film formation, impurity implantation, and the like) on the semiconductor substrate (for example, a silicon substrate).

The semiconductor region 21 is a p-type (first conductivity type) region and is provided along the second surface 20b in the semiconductor layer 20. As an example, the semiconductor region 21 is a p-type region having a carrier concentration of 1×10¹⁵ cm⁻³ or less and a thickness of about 10 μm.

The avalanche multiplication region 22 includes a first multiplication region 22a and a second multiplication region 22b. The first multiplication region 22a is a p-type region and is formed on the first side of the semiconductor region 21 in the semiconductor layer 20. As an example, the first multiplication region 22a is a p-type region having a carrier concentration of 1×10¹⁶ cm⁻³ or more and a thickness of about 1 μm. The second multiplication region 22b is an n-type (second conductivity type) region and is formed on the first side of the first multiplication region 22a in the semiconductor layer 20. As an example, the second multiplication region 22b is an n-type region having a carrier concentration of 1×10′⁶ cm⁻³ or more and a thickness of about 1 μm. The first multiplication region 22a and the second multiplication region 22b form a pn junction.

The charge distribution region 23 is an n-type region and is formed on the first side of the second multiplication region 22b in the semiconductor layer 20. As an example, the charge distribution region 23 is an n-type region having a carrier concentration of 5×10¹⁵ to 1×10¹⁶ cm⁻³ and a thickness of about 1 μm.

Each of the charge accumulation regions 24 and 25 is an n-type region and is formed on the first side of the second multiplication region 22b in the semiconductor layer 20. Each of the charge accumulation regions 24 and 25 is connected to the charge distribution region 23. The pair of charge accumulation regions 24 and 25 face each other in the X direction with a portion of the first side of the charge distribution region 23 interposed therebetween. As an example, each of the charge accumulation regions 24 and 25 is an n-type region having a carrier concentration of 1×10¹⁸ cm⁻³ or more and a thickness of about 0.2 μm. A portion of the second side of the charge distribution region 23 is located between each of the charge accumulation regions 24 and 25 and the second multiplication region 22b.

Each of the charge discharge regions 26 and 27 is an n-type region and is formed on the first side of the second multiplication region 22b in the semiconductor layer 20. Each of the charge discharge regions 26 and 27 is connected to the charge distribution region 23. The pair of charge discharge regions 26 and 27 face each other in the Y direction with the first side portion of the charge distribution region 23 interposed therebetween. As an example, each of the charge discharge regions 26 and 27 is an n-type region having a carrier concentration of 1×10¹⁸ cm⁻³ or more and a thickness of about 0.2 μm. A portion of the second side in the charge distribution region 23 is located between each of the charge discharge regions 26 and 27 and the second multiplication region 22b.

Each charge blocking region 28 is a p-type region and is formed in the semiconductor layer 20 between each of the charge accumulation regions 24 and 25 and the charge distribution region 23 (portion of the second side in the charge distribution region 23). As an example, each charge blocking region 28 is a p-type region having a carrier concentration of 1×10¹⁷ to 1×10¹⁸ cm⁻³ and a thickness of about 0.2 μm.

The well region 31 is a p-type region and is formed on the first side of the second multiplication region 22b in the semiconductor layer 20. The well region 31 surrounds the charge distribution region 23 when viewed from the Z direction. The LOCOS region 33 is formed on the first side of the well region 31 in the semiconductor layer 20. The LOCOS region 33 is connected to the well region 31. The well region 31 constitutes a plurality of read circuits (for example, source follower amplifier, reset transistor, and the like) together with the LOCOS region 33. The plurality of read circuits are electrically connected to the charge accumulation regions 24 and 25, respectively. As an example, the well region 31 is a p-type region having a carrier concentration of 1×10¹⁶ to 5×10¹⁷ cm⁻³ and a thickness of about 1 μm. As a structure for electrically separating the pixel unit and the read circuit unit, STI (Shallow Trench Isolation) may be used instead of the LOCOS region 33, or only the well region 31 may be used.

The barrier region 34 is an n-type region and is formed between the second multiplication region 22b and the well region 31 in the semiconductor layer 20. The barrier region 34 includes the well region 31 when viewed from the Z direction. That is, the well region 31 is located within the barrier region 34 when viewed from the Z direction. The barrier region 34 surrounds the charge distribution region 23. The n-type impurity concentration of the barrier region 34 is higher than the n-type impurity concentration of the second multiplication region 22b. As an example, the barrier region 34 is an n-type region having a carrier concentration from the carrier concentration of the second multiplication region 22b up to about twice the carrier concentration of the second multiplication region 22b and has a thickness of about 1 μm.

Each sink region 35 is an n-type region and is formed on the first side of the barrier region 34 in the semiconductor layer 20. An end portion of each sink region 35 on the second side is connected to the barrier region 34. An end portion of each sink region 35 on the first side is connected to each of the charge discharge regions 26 and 27. The n-type impurity concentration of each of the charge discharging regions 26 and 27 is higher than the n-type impurity concentration of each sink region 35, and the n-type impurity concentration of each sink region 35 is higher than the n-type impurity concentration of the barrier region 34 and the p-type impurity concentration of the well region 31. As an example, each sink region 35 is an n-type region having a carrier concentration or more of the well region 31, and the thickness thereof depends on the distance between each of the charge discharge regions 26 and 27 and the barrier region 34.

Each pixel 11a has a photogate electrode 41, a pair of first transfer gate electrodes 42 and 43, and a pair of second transfer gate electrodes 44 and 45 in the electrode layer 40. Each gate electrode 41 to 45 is formed on the first surface 20a of the semiconductor layer 20 via an insulating film 46. The insulating film 46 is, for example, a silicon nitride film, a silicon oxide film, or the like.

The photogate electrode 41 is formed on the first side of the charge distribution region 23 in the electrode layer 40. The photogate electrode 41 is made of a conductive and optically transparent material (for example, polysilicon). As an example, the photogate electrode 41 has a rectangular shape with two sides facing each other in the X direction and two sides facing each other in the Y direction when viewed from the Z direction.

Among the semiconductor region 21, the avalanche multiplication region 22, and the charge distribution region 23, a region immediately below the photogate electrode 41 (a region overlapping the photogate electrode 41 when viewed from the Z direction) functions as a charge generation region (a light absorption region, a photoelectric conversion region) 36 that generates charges in response to incident light. In other words, the photogate electrode 41 is arranged on the charge generation region 36. In the charge generation region 36, charges generated in the semiconductor region 21 are multiplied in the avalanche multiplication region 22 and distributed in the charge distribution region 23.

The first transfer gate electrode 42 is arranged on a region between the charge generation region 36 and the charge accumulation region 24 in the charge distribution region 23. The first transfer gate electrode 43 is arranged on a region between the charge generation region 36 and the charge accumulation region 25 in the charge distribution region 23. Each of the first transfer gate electrodes 42 and 43 is made of a conductive and optically transparent material (for example, polysilicon). As an example, each of the first transfer gate electrodes 42 and 43 has a rectangular shape with two sides facing each other in the X direction and two sides facing each other in the Y direction when viewed from the Z direction.

The second transfer gate electrode 44 is arranged on a region between the charge generation region 36 and the charge discharge region 26 in the charge distribution region 23. The second transfer gate electrode 45 is arranged on a region between the charge generation region 36 and the charge discharge region 27 in the charge distribution region 23. Each of the second transfer gate electrodes 44 and 45 is made of a conductive and optically transparent material (for example, polysilicon). As an example, each of the second transfer gate electrodes 44 and 45 has a rectangular shape with two sides facing each other in the X direction and two sides facing each other in the Y direction when viewed from the Z direction.

The distance measurement sensor 10 further includes a facing electrode 50 and the wiring layer 60 in the pixel unit 11. The facing electrode 50 is provided on the second surface 20b of the semiconductor layer 20. The facing electrode 50 includes the plurality of pixels 11a when viewed from the Z direction. The facing electrode 50 faces the electrode layer 40 in the Z direction. The facing electrode 50 is made of, for example, a metal material. The wiring layer 60 is provided on the first surface 20a of the semiconductor layer 20 so as to cover the electrode layer 40. The wiring layer 60 is electrically connected to each pixel 11a and the CMOS read circuit unit 12 (refer to FIG. 1). A light incidence opening 60a is formed in a portion of the wiring layer 60 facing the photogate electrode 41 of each pixel 11a.

A trench 29 is formed in the semiconductor layer 20 so as to separate each pixel 11a from each other. The trench 29 is formed in the first surface 20a of the semiconductor layer 20. A bottom surface 29a of the trench 29 is located on the second side with respect to the avalanche multiplication region 22. That is, the trenches 29 completely separate the avalanche multiplication regions 22. An insulating material 47 such as a silicon oxide is arranged within the trench 29. Instead of the insulating material 47, a metal material such as tungsten or polysilicon may be arranged in the trench 29.

In each pixel 11a, the avalanche multiplication region 22 reaches the trench 29. The avalanche multiplication region 22 is a region that causes the avalanche multiplication. In each pixel 11a, an avalanche multiplication region 22 that can generate an electric field intensity of 3×10⁵ to 4×10⁵ V/cm when a reverse bias of a predetermined value is applied extends over the entire region surrounded by the trench 29.

### Distance Image Acquisition Method

An operation example (distance image acquisition method) of the distance image acquisition device 1 will be described. The following operations are realized by the control unit 4 controlling the driving of each section. First, a method of detecting the pulsed light L by the distance measurement sensor 10 will be described.

In each pixel 11a of the distance measurement sensor 10, a negative voltage (for example, −50 V) is applied to the facing electrode 50 with the potential of the photogate electrode 41 as a reference. That is, a reverse bias is applied to the pn junction formed in the avalanche multiplication region 22. Accordingly, an electric field intensity of 3×10⁵ to 4×10⁵ V/cm is generated in the avalanche multiplication region 22. In this state, when the pulsed light L is incident on the semiconductor layer 20 through the light incidence opening 60a and the photogate electrode 41, the charges (electrons) generated by absorption of the pulsed light L are multiplied in the avalanche multiplication region 22 and move to the charge distribution region 23 at a high speed.

Pulse voltage signals (voltage signals TX1 and TX2 described later) are applied to the first transfer gate electrodes 42 and 43 of each pixel 11a. The pulse voltage signals applied to the first transfer gate electrodes 42 and 43 are, for example, voltage signals in which a positive voltage (on) and a negative voltage (off) are alternately repeated with the potential of the photogate electrode 41 as a reference. During the period when the positive voltage is applied to the first transfer gate electrode 42, the charges are transferred from the charge distribution region 23 to the charge accumulation region 24 at a high speed, and during the period when the positive voltage is applied to the first transfer gate electrode 43, the charges are transferred from the charge distribution region 23 to the charge accumulation region 25 at a high speed.

The pulse voltage signals applied to the first transfer gate electrodes 42 and 43 are set to be turned on at different timings as described later. Accordingly, the charges moved to the charge distribution region 23 are transferred and distributed to the charge accumulation regions 24 and 25 at the transfer timing in accordance with the pulse voltage signals. The charges accumulated in the charge accumulation regions 24 and 25 by the transferring for a predetermined period are transferred to be read as signals to the CMOS read circuit unit 12 (refer to FIG. 1) through the read circuit configured by the well region 31 and the like and the wiring layer 60. The amount of charges accumulated in the charge accumulation regions 24 and 25 corresponds to a light quantity (intensity) of the pulsed light L incident on the charge generation region 36 during the period when the positive voltage is applied to the first transfer gate electrodes 42 and 43. As described above, in the distance measurement sensor 10, the pulsed light L can be detected by transferring the charges generated in the charge generation region 36 in response to the incidence of the pulsed light L reflected by the target object OJ to the charge accumulation regions 24 and 25 by using the first transfer gate electrodes 42 and 43.

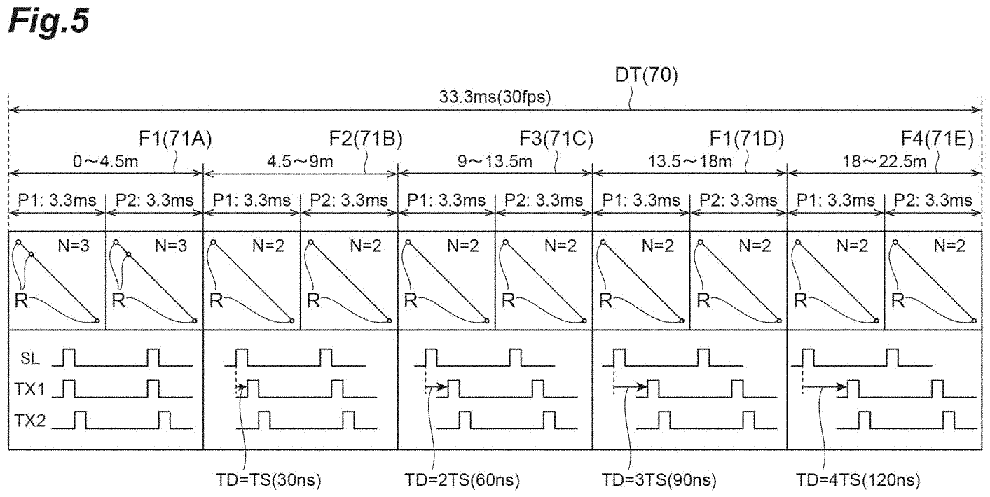

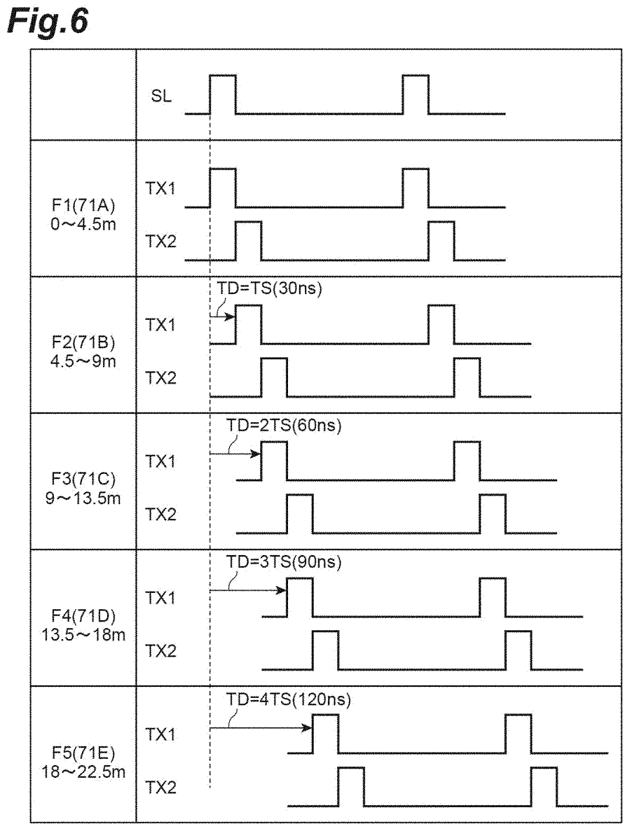

Next, an operation example of the distance image acquisition device 1 will be described with reference to FIGS. 5 and 6. As illustrated in FIGS. 5 and 6, in this distance image acquisition method, an entire distance range 70 of a measurement target is divided into a plurality of sections (units of a distance range). In this example, the plurality of sections include five sections 71A to 71E. The lengths of the sections 71A to 71E are equal to each other. As an example, the entire distance range 70 is 22.5 m, and the length of each of the sections 71A to 71E is 4.5 m. The sections 71A, 71B, 71C, 71D, and 71E are closer to the light source in this order. That is, the section 71A is in the range of 0 m to 4.5 m from the light source 2, the section 71B is in the range of 4.5 m to 9 m from the light source 2, the section 71C is in the range of 9 m to 13.5 m from the light source 2, the section 71D is in the range of 13.5 m to 18 m from the light source 2, and the section 71E is in the range of 18 m to 22.5 m from the light source 2.

In this distance image acquisition method, the measurement about each of the sections 71A to 71E is performed. In this example, the frame rate is 30 fps and the length of one data DT is 33.3 ms. The data DT includes five sub-frames F1 to F5 corresponding to the sections 71A to 71E. That is, in this distance image acquisition method, a frame (data DT) corresponding to the entire distance range 70 is time-divided into the plurality of sub-frames F1 to F5. The sub-frames F1 to F5 have equal lengths, which is 6.6 ms in this example.

Each of the sub-frames F1 to F5 includes a first period P1 and a second period P2 following the first period P1. In the first period P1, the pulsed light L is emitted from the light source 2, and the pulsed light L reflected by the target object OJ is detected by the distance measurement sensor 10. During the second period P2, the pulsed light L is not emitted from the light source 2, and only the background light is detected by the distance measurement sensor 10. That is, the measurement light and the background light are detected during the first period P1, and only the background light is detected during the second period P2. When generating the distance image of the target object OJ, the difference between the signal acquired in the first period P1 and the signal acquired in the second period P2 is the signal light. The length of the first period P1 is equal to the length of the second period P2 and is 3.3 ms in this example.

In each of the sub-frames F1 to F5, the measurements about the sections 71A to 71E are performed while varying a time difference TD between the emission timing of the pulsed light L by the light source 2 and the transfer timing of the charges by the first transfer gate electrodes 42 and 43 among the sections 71A to 71E. Hereinafter, details of the operation in each of the sub-frames F1 to F5 will be described. FIGS. 5 and 6 illustrate the intensity signal SL of the pulsed light L emitted from the light source 2, the voltage signal TX1 applied to the first transfer gate electrode 42, and the voltage signal TX2 applied to the first transfer gate electrode 43.

As illustrated in FIGS. 5 and 6, in the sub-frame F1, the voltage signal TX1 applied to the first transfer gate electrode 42 has the same period, pulse width, and phase as the intensity signal SL of the pulsed light L emitted from the light source 2. That is, in the sub-frame F1, there is no time difference TD between the emission timing and the transfer timing (time difference TD is zero). The voltage signal TX2 applied to the first transfer gate electrode 43 rises and is turned on immediately after the voltage signal TX1 of the first transfer gate electrode 42 is turned off. The voltage signal TX2 has the same period and pulse width as the intensity signal SL and the voltage signal TX1. The pulse widths of the pulsed light L and the voltage signals TX1 and TX2 are, for example, 30 ns. During the period when both the voltage signals TX1 and TX2 are turned off, a positive voltage is applied to the second transfer gate electrodes 44 and 45, and charges are transferred from the charge distribution region 23 to the charge discharge regions 26 and 27 at a high speed. The charges transferred to the charge discharge regions 26 and 27 are discharged to the outside.

In FIG. 5, reference symbol R denotes the timing at which the charges accumulated in the charge accumulation regions 24 and 25 are read. As illustrated in FIG. 5, in the sub-frame F1, in each of the first period P1 and the second period P2, the charges are read once between the start point and the end point in addition to the start point and the end point of the period. That is, the number N of times of read is three.

As illustrated in FIG. 1, when the pulsed light L is emitted from the light source 2 and the pulsed light L reflected by the target object OJ is detected by the distance measurement sensor 10, the phase of the intensity signal of the pulsed light L detected by the distance measurement sensor 10 is shifted from the phase of the intensity signal SL of the pulsed light L emitted from the light source 2 in accordance with the distance d to the target object OJ. Therefore, the data for generating the distance image about the section 71A can be obtained by acquiring the amount of charges accumulated in the charge accumulation regions 24 and 25 in the sub-frame F1 for each pixel 11a.

In the sub-frame F2, the phase of the voltage signal TX1 applied to the first transfer gate electrode 42 is shifted from the intensity signal SL of the pulsed light L emitted from the light source 2 by a time TS. That is, in the sub-frame F2, the time difference TD is the time TS. The time TS corresponds to the section 71B and is, for example, 30 ns. In this example, the time TS is equal to the pulse width of the pulsed light L. The voltage signals TX1 and TX2 are the same as the sub-frame F1 for other points. As illustrated in FIG. 5, in the sub-frame F2, in each of the first period P1 and the second period P2, the charges are read twice at the start and end points of the period, and the number N of times of read is two. The data for generating the distance image about the section 71B can be obtained by acquiring the amount of charges accumulated in the charge accumulation regions 24 and 25 in the sub-frame F2 for each pixel 11a.

In the sub-frame F3, the phase of the voltage signal TX1 applied to the first transfer gate electrode 42 is shifted from the intensity signal SL of the pulsed light L emitted from the light source 2 by twice the time TS. That is, in the sub-frame F3, the time difference TD is a time 2TS. The time 2TS corresponds to the section 71C and is, for example, 60 ns. The voltage signals TX1 and TX2 are the same as the sub-frame F1 for other points. The number N of times of read of the sub-frame F3 is two, similarly to the sub-frame F2. The data for generating the distance image about the section 71C can be obtained by acquiring the amount of charges accumulated in the charge accumulation regions 24 and 25 in the sub-frame F3 for each pixel 11a.

In the sub-frame F4, the phase of the voltage signal TX1 applied to the first transfer gate electrode 42 is shifted from the intensity signal SL of the pulsed light L emitted from the light source 2 by three times the time TS. That is, in the sub-frame F4, the time difference TD is a time 3TS. The time 3TS corresponds to the section 71D and is, for example, 90 ns. The voltage signals TX1 and TX2 are the same as the sub-frame F1 for other points. The number N of times of read in the sub-frame F4 is two, similarly to the sub-frame F2. The data for generating the distance image about the section 71D can be obtained by acquiring the amount of charges accumulated in the charge accumulation regions 24 and 25 in the sub-frame F4 for each pixel 11a.

In the sub-frame F5, the phase of the voltage signal TX1 applied to the first transfer gate electrode 42 is shifted from the intensity signal SL of the pulsed light L emitted from the light source 2 by four times the time TS. That is, in the sub-frame F5, the time difference TD is a time 4TS. The time 4TS corresponds to the section 71E and is, for example, 120 ns. The voltage signals TX1 and TX2 are the same as the sub-frame F1 for other points. The number N of times of read of the sub-frame F4 is two, similarly to the sub-frame F2. The data for generating the distance image about the section 71E can be obtained by acquiring the amount of charges accumulated in the charge accumulation regions 24 and 25 in the sub-frame F5 for each pixel 11a.

In this manner, the measurements about the sections 71A to 71E are performed while varying the time difference TD between the emission timing of the pulsed light L by the light source 2 and the transfer timing of the charges by the first transfer gate electrodes 42 and 43 among the sections 71A to 71E. More specifically, the time difference TD is varied among the sections 71A to 71E by fixing the emission timing and shifting the transfer timing from the emission timing. In addition, in the measurement about the section 71A (sub-frame F1), the charges accumulated in the charge accumulation regions 24 and 25 are read at a higher reading frequency (a large number N of times of read) than in the measurements about the sections 71B to 71E (sub-frames F2 to F5) which are farther from the light source 2 than the section 71A. In addition, the lengths of the first period P1 in the sub-frames F1 to F5 are 3.3 ms and equal to each other, and the charge accumulation times (exposure times) in the measurements about the sections 71A to 71E are equal to each other.

In the distance image acquisition method of the embodiment, the distance image of the entire distance range 70 is generated based on the measurement results about the sections 71A to 71E. That is, the data for generating the distance images for the sections 71A to 71E can be obtained by the measurements about the sections 71A to 71E (sub-frames F1 to F5). By combining these data, the distance image of the entire distance range 70 can be generated.

### Function and Effect

As described above, in the distance image acquisition device 1, the charge generation region 36 includes the avalanche multiplication region 22 that causes the avalanche multiplication. Accordingly, the sensitivity of the distance measurement sensor 10 can be increased, and as a result, the measurement distance can be extended. On the other hand, as described above, generally, the pulse width of the pulsed light L needs to be widened in order to extend a measurement distance, and the widening of the pulse width degrades a distance accuracy. In this respect, in the distance image acquisition device 1, the entire distance range 70 of the measurement target is divided into the plurality of sections 71A to 71E, the measurements about the sections 71A to 71E are performed while varying the time difference TD between the emission timing of the pulsed light L by the light source 2 and the transfer timing by the first transfer gate electrodes 42 and 43 among the sections 71A to 71E, and the distance image of the entire distance range 70 is generated based on the results of the measurements about the sections 71A to 71E. Accordingly, even when the measurement distance is long, the widening of the pulse width of the pulsed light L can be suppressed, and the distance accuracy can be ensured.

For example, unlike the distance image acquisition device 1, when the measurement about the entire distance range 70 is performed without the division into the sections 71A to 71E, the pulse width is about 150 ns, as described later. That is, in the indirect TOF method, the following equation (1) is satisfied.

ΔD=cW/2 (1)

ΔD is the distance accuracy, c is the speed of light, and W is the pulse width of the pulsed light L. When the distance accuracy ΔD is set to be 22.5 m and the speed of light c is set to be 3×10⁸ m/s in Equation (1), the pulse width W becomes 150 ns. In contrast, in the distance image acquisition device 1, as described above, the pulse width W of the pulsed light L is 30 ns, and the distance accuracy ΔD is 4.5 m. That is, the distance accuracy ΔD is improved to ⅕ (30 ns/150 ns) compared to the case where the division into the sections 71A to 71E is not performed. In this manner, the distance image acquisition device 1 acquires the distance data by time-dividing the distance measurement range, so that the distance accuracy can be improved while the distance is increased. It is noted that, in practice, the right handed side of the above equation (1) can be further multiplied by an N/S ratio.

Further, when the division into the sections 71A to 71E is simply performed, there is a concern that the charge accumulation time (exposure time) may decrease and the charge accumulation amount may be insufficient. However, in the distance image acquisition device 1, since charge generation region 36 includes the avalanche multiplication region 22, the shortage of the charge accumulation amount can be suppressed. For this reason, it is hardly necessary to increase the charge accumulation time in order to compensate for the shortage of the charge accumulation amount. Furthermore, by performing the division into the sections 71A to 71E, the deterioration in the measurement accuracy caused by the existence of a transparent object or a translucent object between the distance measurement sensor 10 and the target object can be suppressed (multi echo). For example, unlike the distance image acquisition device 1, when the measurement about the entire distance range 70 is performed without the division into the sections 71A to 71E, there is a concern that an average distance of the distance to the object located in the section 71A and the distance to the object located in the section 71E is output, and the measurement accuracy is deteriorated. Consequently, since the distance image acquisition device 1 performs the division into the sections 71A to 71E, such the deterioration in the measurement accuracy can be suppressed. As described above, according to the distance image acquisition device 1, the measurement distance can be extended, and the distance accuracy can be ensured.

In the measurement about the section 71A (first section), the charges accumulated in the charge accumulation regions 24 and 25 are read at a higher reading frequency (a large number N of times of read) than in the measurements about the sections 71B to 71E (second section) which are farther from the light source 2 than the section 71A. Accordingly, the signal saturation in which the charge generation region 36 is saturated during the measurement about the section 71A can be suppressed. Such suppression of the saturation is particularly effective when the charge generation region 36 includes the avalanche multiplication region 22. The reason why the signal saturation is likely to occur in the measurement about the section 71A is that the closer the section is to the light source 2, the higher the intensity of the pulsed light L that is reflected by the target object OJ and returns to the distance measurement sensor 10.

The distance measurement sensor 10 includes a pair of charge accumulation regions 24 and 25 and a pair of first transfer gate electrodes 42 and 43 arranged respectively on regions between the charge generation region 36 and the pair of charge accumulation regions 24 and 25. Even in such a configuration, the measurements about the sections 71A to 71E can be performed by dividing the entire distance range 70 of the measurement target into the plurality of sections 71A to 71E and while varying the time difference TD between the emission timing and the transfer timing among the sections 71A to 71E.

The time difference TD between the emission timing and the transfer timing is allowed to be varied among the sections 71A to 71E by fixing the emission timing of the pulsed light L and shifting the transfer timing of the charges by the first transfer gate electrodes 42 and 43 from the emission timing of the pulsed light L. Accordingly, the time difference TD between the emission timing and the transfer timing can be varied among the sections 71A to 71E.

The charge accumulation times (exposure times) in the measurements about the sections 71A to 71E are equal to each other. Accordingly, the distance image can be acquired at a higher speed, for example, than the case where the charge accumulation time is increased in the measurement about the section (for example, the section 71E) which is far from the light source 2 and in which the charge accumulation amount is likely to be insufficient.

### MODIFIED EXAMPLE

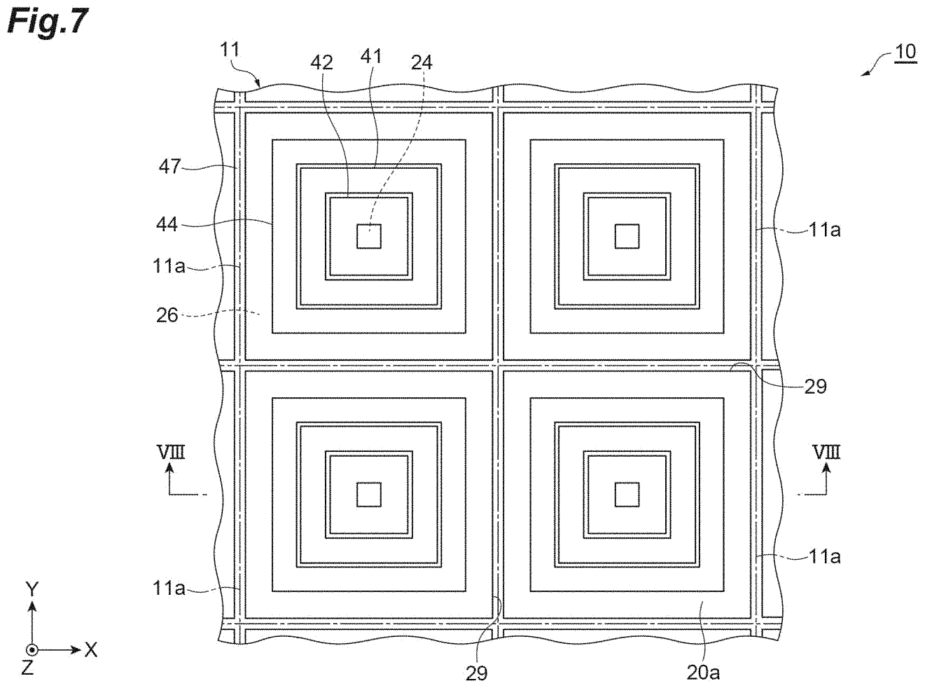

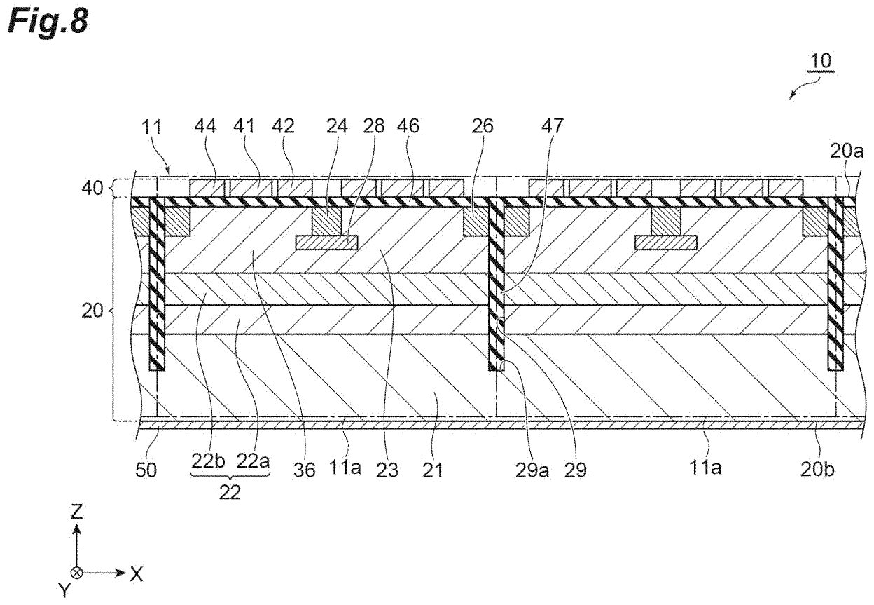

The distance measurement sensor 10 may be configured as in Modified Example 1 illustrated in FIGS. 7 and 8. The distance measurement sensor 10 of Modified Example 1 has one charge accumulation region 24, one charge discharge region 26, one first transfer gate electrode 42, and one second transfer gate electrode 44. In other words, the distance measurement sensor 10 does not have the charge accumulation region 25, the charge discharge region 27, the first transfer gate electrode 43, and the second transfer gate electrode 45.

In each pixel 11a of the distance measurement sensor 10 of Modified Example 1, the charge accumulation region 24 is arranged in the central portion of the charge distribution region 23 when viewed from the Z direction. The charge discharge region 26 has, for example, a rectangular ring shape when viewed from the Z direction and is arranged along an outer edge of the charge distribution region 23. The photogate electrode 41 has, for example, a rectangular ring shape when viewed from the Z direction and is arranged outside the charge accumulation region 24 and inside the charge discharge region 26. The first transfer gate electrode 42 has, for example, a rectangular ring shape when viewed from the Z direction and is arranged outside the charge accumulation region 24 and inside the photogate electrode 41. The second transfer gate electrode 44 has, for example, a rectangular ring shape when viewed from the Z direction and is arranged outside the photogate electrode 41 and inside the charge discharge region 26. It is noted that the charge accumulation region 24, the charge discharge region 26, the photogate electrode 41, the first transfer gate electrode 42, and the second transfer gate electrode 44 may be formed in any shape such as an octagon.

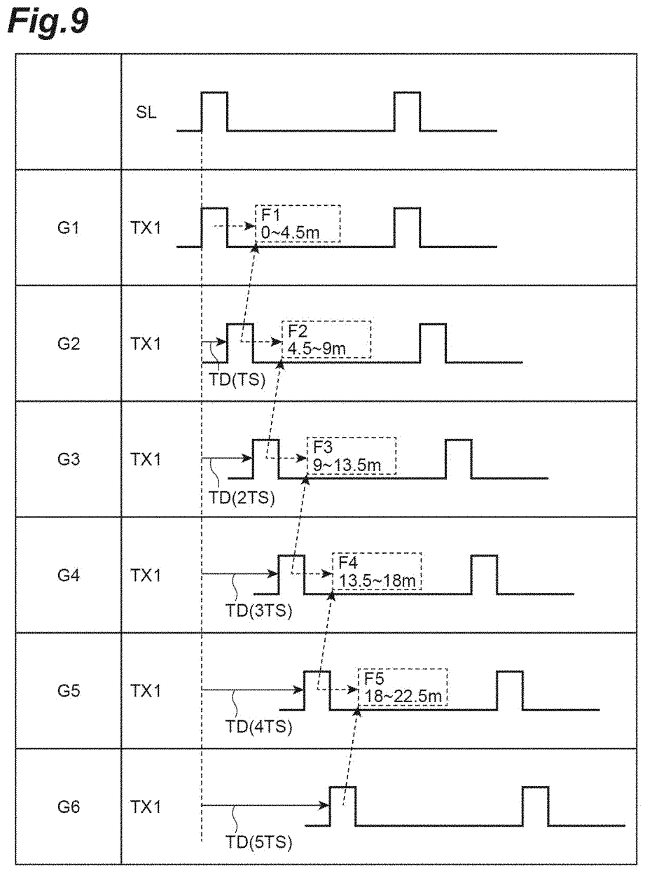

As illustrated in FIG. 9, even when the distance measurement sensor 10 of Modified Example 1 is used, similarly to the above-described embodiment, the measurements about the sections 71A to 71E can be performed while varying the time difference TD between the emission timing of the pulsed light L by the light source 2 and the transfer timing of the charges by the first transfer gate electrode 42 among the sections 71A to 71E.

In FIG. 9, one data is divided into six sub-frames G1 to G6. In the sub-frame G1, the voltage signal TX1 applied to the first transfer gate electrode 42 has the same period, pulse width and phase as the intensity signal SL of the pulsed light L emitted from the light source 2. That is, in the sub-frame G1, there is no time difference TD between the emission timing and the transfer timing (time difference TD is zero). While the voltage signal TX1 is turned off, a positive voltage is applied to the second transfer gate electrode 44, and the charges are transferred from the charge distribution region 23 to the charge discharge region 26 at a high speed. The charges transferred to the charge discharge region 26 are discharged to the outside.

In the sub-frames G2 to G6, the time differences TD are the times TS, 2TS, 3TS, 4TS, and 5TS, respectively. The voltage signal TX1 is similar to the sub-frame G1 for other points.

As illustrated in FIG. 9, the data corresponding to the sub-frame F1 in the above embodiment can be obtained from the data acquired in the adjacent the sub-frames G1 and G2. Similarly, the data corresponding to the sub-frame F3 in the above embodiment can be obtained from the data acquired in the sub-frames G2 and G3. Similarly, the data corresponding to the sub-frames F3 to F5 in the above embodiment can be obtained from the data acquired in the sub-frames G3 to G6. Therefore, the distance image of the entire distance range 70 can be generated based on the measurement results about the sub-frames G1 to G6. According to such Modified Example 1, similarly to the above-described embodiment, the measurement distance can be extended, and the distance accuracy can be ensured.

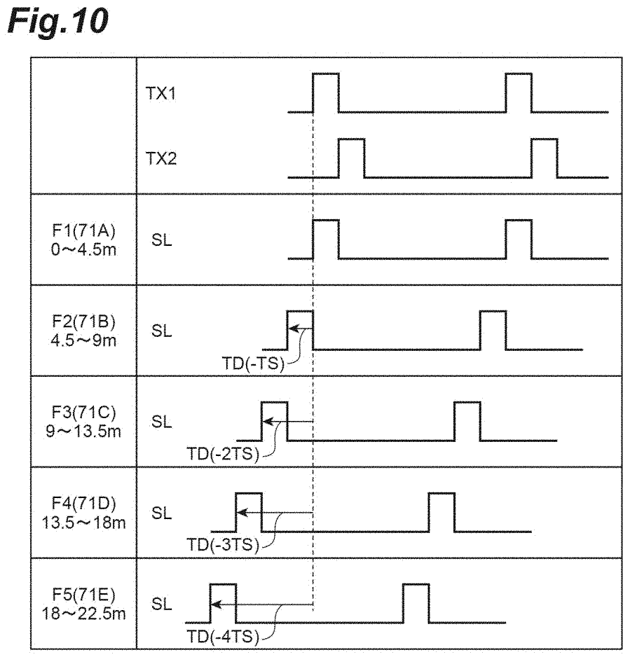

The distance image may be acquired as in Modified Example 2 illustrated in FIG. 10. In Modified Example 2, unlike the above-described embodiment, the time difference TD between the emission timing and the transfer timing is varied among the sections 71A to 71E by fixing the transfer timing of the charges by the first transfer gate electrodes 42 and 43 and shifting the emission timing of the pulsed light L from the transfer timing.

Specifically, in the example of FIG. 10, in the sub-frames F2 to F5, the emission timing of the pulsed light L by the light source 2 is shifted from the transfer timing of the charges by the first transfer gate electrodes 42 and 43 by the times TS, 2TS, 3TS, and 4TS, respectively. Even in this case, the distance image of the entire distance range 70 can be generated by combining the measurement data about the sections 71A to 71E. Therefore, also according to Modified Example 2, similarly to the above-described embodiment, the measurement distance can be extended, and the distance accuracy can be ensured.

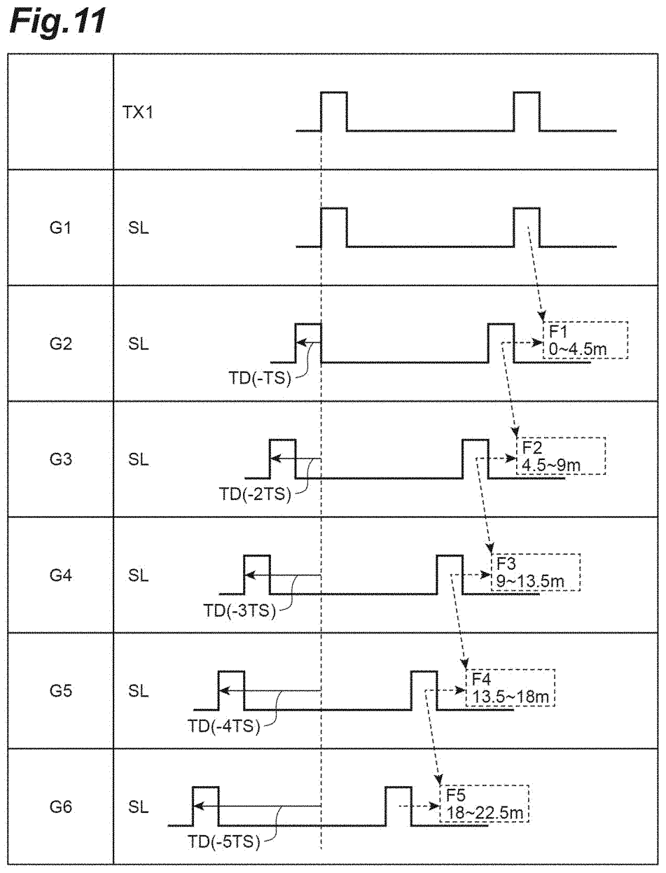

As in Modified Example 3 illustrated in FIG. 11, in Modified Example 1, similarly to in Modified Example 2, the time difference TD between the emission timing and the transfer timing may be varied among the sections 71A to 71E by fixing the transfer timing of the charges by the first transfer gate electrode 42 and shifting the emission timing of the pulsed light L from the transfer timing.

In the example of FIG. 11, in the sub-frames G2 to G6, the emission timing of the pulsed light L by the light source 2 is shifted by the times TS, 2TS, 3TS, 4TS, and 5TS with respect to the transfer timing of the charges by the first transfer gate electrode 42, respectively. Even in this case, the data corresponding to the sub-frames F1 to F5 in the above embodiment can be obtained from the data acquired in the sub-frames G1 to G6, and the distance image of the entire distance range 70 can be generated. Therefore, also according to Modified Example 3, similarly to the above-described embodiment, the measurement distance can be extended, and the distance accuracy can be ensured.

The present disclosure is not limited to the above embodiments and Modified Examples. For example, the material and shape of each configuration are not limited to the materials and shapes described above, and various materials and shapes can be adopted. In the distance measurement sensor 10, the bottom surface 29a of the trench 29 may be located on the first side with respect to the avalanche multiplication region 22, and the avalanche multiplication region 22 may be connected over the plurality of pixels 11a. Alternatively, the trench 29 in the semiconductor layer 20 may not be formed, and the avalanche multiplication region 22 may extend over the plurality of pixels 11a. The charge discharge regions 26 and 27 and the second transfer gate electrodes 44 and 45 may be omitted. Each of the p-type and n-type conductivity types may be reversed for the examples described above. The plurality of pixels 11a may be one-dimensionally arranged along the first surface 20a of the semiconductor layer 20. The distance measurement sensor 10 may have only a single pixel 11a.

The entire distance range 70 may be divided into any number of sections, which is two or more. The lengths of the plurality of sections may be different from each other. The lengths of the first periods P1 in the sub-frames F1 to F5 may be different from each other. That is, the charge accumulation times in the measurements about the sections 71A to 71E may be different from each other. The number N of times of read in the sub-frame F1 may be twice at the start point and the end point of the period or may be four times or more. The number N of times of read in the sub-frames F2 to F5 may be three or more.

In the above embodiment, in the measurement about the section 71A (first section), the charges accumulated in the charge accumulation regions 24 and 25 are read at a higher reading frequency than in the measurements about the sections 71B to 71E (second section) which is farther from the light source 2 than the section 71A, and thus, the signal saturation of the charge generation region 36 during the measurement about the section 71A is suppressed. Alternatively or additionally, the charges accumulated in the charge accumulation regions 24 and 25 may be transferred at a lower transfer frequency in the measurement about the section 71A than in the measurements about the sections 71B to 71E. For example, in the section 71A of the above embodiment, once charge transfer is performed for once emission of the pulsed light L, but once charge transfer may be performed for twice or four times of emission of the pulsed light L. Even in this case, the signal saturation can be suppressed. In this case, the reading frequencies in the sections 71A to 71E may be the same.

### REFERENCE SIGNS LIST

1: distance image acquisition device, 2: light source, 4: control unit, 10: distance measurement sensor, 22: avalanche multiplication region, 24, 25: charge accumulation region, 36: charge generation region, 42, 43: first transfer gate electrode, 70: entire distance range, 71A: section (first section), 71B: section (second section), 71C to 71E: sections, L: pulsed light (measurement light), OJ: target object, TD: time difference.

1. A distance image acquisition device comprising:
a light source that emits a measurement light;
a distance measurement sensor that includes a charge generation region, a charge accumulation region, and a transfer gate electrode arranged on a region between the charge generation region and the charge accumulation region and detects the measurement light by transferring charges generated in the charge generation region in response to incidence of the measurement light emitted from the light source and reflected by a target object, to the charge accumulation region by using the transfer gate electrode; and
a control unit that controls the distance measurement sensor and generates a distance image of the target object based on a detection result of the distance measurement sensor,
wherein the charge generation region includes an avalanche multiplication region that causes avalanche multiplication, and
wherein the control unit:
divides an entire distance range of a measurement target into a plurality of sections;
controls the distance measurement sensor so as to perform measurements about the plurality of sections while varying a time difference between an emission timing of the measurement light by the light source and a transfer timing of the charges by the transfer gate electrode among the plurality of sections; and
generates the distance image of the entire distance range based on the results of the measurements about the plurality of sections.

2. The distance image acquisition device according to claim 1,
wherein the plurality of sections include a first section and a second section farther from the light source than the first section, and
wherein the control unit controls the distance measurement sensor so that the charges accumulated in the charge accumulation region are read at a higher reading frequency in the measurement about the first section than in the measurement about the second section.

3. The distance image acquisition device according to claim 1,
wherein the plurality of sections include a first section and a second section farther from the light source than the first section, and
wherein the control unit controls the distance measurement sensor so that the charges are transferred to the charge accumulation region at a lower transfer frequency in the measurement about the first section than in the measurement about the second section.

4. The distance image acquisition device according to claim 1,
wherein the charge accumulation region includes a pair of charge accumulation regions, and
wherein the transfer gate electrode include a pair of transfer gate electrodes arranged respectively on the regions between the charge generation region and the pair of charge accumulation regions.

5. The distance image acquisition device according to claim 1, wherein the distance measurement sensor includes only one region as the charge accumulation region and includes only one electrode as the transfer gate electrode.

6. The distance image acquisition device according to claim 1, wherein the control unit varies the time difference between the emission timing and the transfer timing among the plurality of sections by fixing the emission timing and shifting the transfer timing from the emission timing.

7. The distance image acquisition device according to claim 1, wherein the control unit varies the time difference between the emission timing and the transfer timing among the plurality of sections by fixing the transfer timing and shifting the emission timing from the transfer timing.

8. The distance image acquisition device according to claim 1, wherein charge accumulation times in the measurements about the plurality of sections are equal to each other.

9. A distance image acquisition method of acquiring a distance image of a target object,
using a light source that emits a measurement light; and
a distance measurement sensor that includes a charge generation region, a charge accumulation region, and a transfer gate electrode arranged on a region between the charge generation region and the charge accumulation region and detects the measurement light by transferring charges generated in the charge generation region in response to incidence of the measurement light emitted from the light source and reflected by a target object, to the charge accumulation region by using the transfer gate electrode, the charge generation region including an avalanche multiplication region that causes avalanche multiplication,
the distance image acquisition method comprising:
dividing an entire distance range of a measurement target into a plurality of sections;
performing measurements about the plurality of sections while varying the time difference between the emission timing of the measurement light by the light source and the transfer timing of the charges by the transfer gate electrode among the plurality of sections; and
generating the distance image of the entire distance range based on the results of the measurements about the plurality of sections.
